(19) United States
(12) Patent Application Publication
(10) Pub. No.: US 2025/0053378 A1
(43) Pub. Date: Feb. 13, 2025

(54) METHOD AND APPARATUS FOR FLOATING POINT ARITHMETIC

(71) Applicant: SEOUL NATIONAL UNIVERSITY R&DB FOUNDATION, Seoul (KR)

(72) Inventors: Hyuk Jae LEE, Seoul (KR); Boyeal KIM, Seoul (KR); Jongchan KIM, Seoul (KR)

(21) Appl. No.: 18/719,112

(22) PCT Filed: Dec. 13, 2022
(86) PCT No.: PCT/KR2022/020283

§ 371 Date: Jun. 12, 2024

(30) Foreign Application Priority Data
Dec. 14, 2021 (KR) 10-2021-0178593
Dec. 9, 2022 (KR) 10-2022-0171706

(51) Int. Cl. G06F 7/485; G06F 5/01; G06F 7/02

(52) U.S. Cl. CPC G06F 7/485; G06F 5/012; G06F 7/02

(57) ABSTRACT

An example of a floating point arithmetic method comprises: storing bit information of a mantissa of at least one operand selected from among at least two operands based on a result of comparing exponents of the at least two operands being input; outputting an operation result of higher bits by calculating the at least two operands; and outputting an operation result of lower bits by adding, to the bit information of the mantissa of the at least one operand, a bit lost through a normalization operation and a rounding operation in the calculation of the at least two operands. Accordingly, the method can accelerate high-precision arithmetic by adding, to a floating point operator, hardware that calculates an error in a floating point addition operation, and, via instructions supporting the same, can configure an efficient processor.

### TECHNICAL FIELD

The present disclosure relates to floating point arithmetic, and to an operator supporting approximate double-length floating point arithmetic and a processor including the same.

This work was partly supported by Institute for Information & communications Technology Promotion (IITP) grant funded by the Korea government (MSIT) (Project unique No.: 1711117060; Project No.: 2020-0-01305-001; R&D project: Next-Generation Intelligent Semiconductor Technology Development (Design) (R&D) Research Project; and Research Project Title: Development of 2,000 TFLOPS-class Server Artificial Intelligence Deep Learning Processor and Modules) and partly supported by IITP grant funded by the Korea government (MSIT) (Project unique No.: 1711125960; Project No.: 2020-0-01461-002; R&D project: Information and Communication Broadcasting Innovation Talent Development (R&D) Research Project; and Research Project Title: Development of Intelligent Medical Imaging Diagnosis Solutions).

### BACKGROUND ART

Floating point representation may be classified according to the number of bits. Usually, single-precision arithmetic using 32 bits or double-precision arithmetic using 64 bits is used. Most modern processors that require the floating point representation include floating point operators to accelerate floating point arithmetic, and each floating point operator generally supports only a certain number of bits of floating point arithmetic.

In order to support the floating point arithmetic of various precisions, floating point operators for each precision are implemented in hardware, or floating point operators of the highest precision are implemented and then converted from low precision into high precision for calculation. The problem is that a size of hardware increases in proportion to a square of precision that should be supported, which poses a large burden on hardware development. In particular, when high-precision arithmetic is very rarely needed, adding hardware for the high-precision arithmetic results in a large waste of chip area.

Specifically, double-precision floating point represents a number with 64 bits, and single precision floating point represents a number with 32 bits. Although the number of bits has doubled, a hardware size of a floating-point unit (FPU) that supports this has changed in proportion to a square of the number of bits (in proportion to 4 times the size). For this reason, supporting the high-precision floating point arithmetic may be a heavy burden on hardware.

### DETAILED DESCRIPTION OF INVENTION

### Technical Problems

According to one embodiment of the present disclosure, the present disclosure provides a low-precision floating point arithmetic technique capable of representing one high-precision floating point representation as two low-precision floating point representations for hardware acceleration.

According to one embodiment of the present disclosure, the present disclosure provides a processor including a low-precision apparatus for floating point arithmetic designed in this way and a method of driving a calculation device. The present disclosure may be applied to the field of a processor design, and in particular, to an artificial intelligence semiconductor design.

The aspects of the present disclosure are not limited to the foregoing, and other aspects not mentioned herein will be clearly understood by those skilled in the art from the following description.

### Technical Solution

In accordance with an aspect of the present disclosure, there is provided a method for floating point arithmetic performed by an apparatus for floating point arithmetic, the method comprises storing bit information of a mantissa of at least one operand selected from among at least two operands based on a result of comparing exponents of the at least two operands being input; outputting an operation result of higher bits by calculating the at least two operands; and outputting an operation result of lower bits by adding, to the bit information of the mantissa of the at least one operand, a bit lost through a normalization operation and a rounding operation in the calculation of the at least two operands.

Herein, the storing the bit information of the mantissa of the at least one operand may include performing a shift operation of the at least two operands so that the exponents of the at least two operands have a same value; and storing the bit information of the mantissa of an operand having the exponent of a smaller value among the at least two operands in the shift operation.

Additionally, the shift operation may be a right shift operation.

In accordance with another aspect of the present disclosure, there is provided a method for floating point arithmetic performed by apparatus for floating point arithmetic, the method comprises: performing a right shift operation of a first operand and a second operand so that an exponent of the first operand and an exponent of the second operand being input have a same value; storing discarded bits of the second operand during the right shift operation of the first operand and the second operand; calculating the first operand and the second operand and outputting an operation result of higher N bits; and outputting an operation result of lower N bits by adding, to the discarded bits of the second operand, bits lost through a normalization operation and a rounding operation in the calculation of the right shift operation of the first operand and the second operand.

Herein, the discarded bit may be stored in a mantissa of a flip-flop of the apparatus for floating point arithmetic.

Additionally, the adding may include performing a left shift operation or a right shift operation on the mantissa of the operation result of the higher N bits.

Additionally, the mantissa of the discarded bit in the left shift operation may be left shifted.

Additionally, the lost bit in the right shift operation may be added to a most significant bit of the discarded bit.

Additionally, the method may further comprise adjusting the exponent of the discarded bit in response to the left shift operation or the right shift operation.

Additionally, the method may further comprise comparing the sizes of the exponents of the first operand and the second operand and inputting a sign of the discarded bit.

In accordance with another aspect of the present disclosure, there is provided an apparatus for floating point arithmetic, the apparatus comprises: a comparator configured to compare exponents of at least two operands; a controller configured to control to store bit information of a mantissa of at least one operand among the at least two operands in a flip-flop based on a comparison result of the comparator; a first adder and subtractor configured to perform an addition operation or a subtraction operation on the at least two operands based on the control of the controller and output an operation result of a higher bit; and a second adder and subtractor configured to output an operation result by a normalization operation and a rounding operation after the addition or subtraction operation of the first adder and subtractor, wherein the controller is configured to control the second adder and subtractor to output an operation result of lower bits by adding bits lost through a normalization operation and a rounding operation to the bit information of the mantissa of the at least one operand.

Herein, the apparatus may further comprise a shifter configured to perform a shift operation of the at least two operands so that the exponents of the at least two operands have a same value.

Additionally, the controller may be configured to store, in the flip-flop, bit information of a mantissa of an operand having an exponent of a smaller value among the at least two operands during the shift operation.

Additionally, the shift operation may be a right shift operation.

Additionally, the shifter may be configured to perform a right shift operation of a first operand and a second operand so that exponents of a first operand and a second operand being input have the same value; the first adder and subtractor may be configured to operate the first operand and the second operand and outputs an operation result of the higher N bits, the second adder and subtractor may be configured to output an operation result of the lower N bits by the normalization operation and the rounding operation in the calculation of the first operand and the second operand, and the controller may be configured to control a discarded bit of the second operand to be stored in the flip-flop during the right shift operation, and control the second adder subtractor to output the operation result of the lower N bits by adding the bit lost through the normalization operation and the rounding operation to the discarded bit.

In accordance with another aspect of the present disclosure, there is provided a non-transitory computer readable storage medium storing computer executable instructions, wherein the instructions, when executed by a processor, cause the processor to perform a method for floating point arithmetic performed by apparatus for floating point arithmetic, the method comprises storing bit information of a mantissa of at least one operand selected from among at least two operands based on a result of comparing exponents of the at least two operands being input; outputting an operation result of higher bits by calculating the at least two operands; and outputting an operation result of lower bits by adding, to the bit information of the mantissa of the at least one operand, a bit lost through a normalization operation and a rounding operation in the calculation of the at least two operands.

In accordance with another aspect of the present disclosure, there is provided computer program including computer executable instructions stored in a non-transitory computer readable storage medium, wherein the instructions, when executed by a processor, cause the processor to perform a method for floating point arithmetic performed by apparatus for floating point arithmetic, the method comprises storing bit information of a mantissa of at least one operand selected from among at least two operands based on a result of comparing exponents of the at least two operands being input; outputting an operation result of higher bits by calculating the at least two operands; and outputting an operation result of lower bits by adding, to the bit information of the mantissa of the at least one operand, a bit lost through a normalization operation and a rounding operation in the calculation of the at least two operands.

### Effect of Invention

According to an embodiment of the present disclosure, it is possible to reduce unnecessary operations and simplify existing operations by attaching additional hardware to a general floating point adder or subtractor. In addition, according to an embodiment of the present disclosure, it is possible to increase accuracy of operation by preserving bits shifted and discarded rather than discarding the bits during a mantissa truncation process which adjusts exponents of two input values to be the same in floating point addition and subtraction operations.

### BRIEF DESCRIPTION OF THE DRAWING

FIG. 1 is a conceptual diagram of an apparatus for floating point arithmetic according to an embodiment of the present disclosure.

FIG. 2 is a detailed block diagram of the apparatus for floating point arithmetic according to an embodiment of the present disclosure.

FIG. 3 is a flowchart illustrating the method of floating point arithmetic of the apparatus 100 for floating point arithmetic according to the embodiment of the present disclosure.

### BEST MODE FOR CARRYING OUT THE INVENTION

In an embodiment of the present disclosure, a mantissa is truncated during the process of adjusting exponents of two operands to be the same during a floating point addition or subtraction operation. In this case, it is possible to increase accuracy of operation by preserving bits that are shifted and discarded rather than discarding the bits.

Specifically, the floating point arithmetic according to the embodiment of the present disclosure may, on the basis of the result of comparing exponents of at least two operands being input, store bit information of a mantissa of any one operand from among the at least two operands, output an operation result of higher bits by calculating the at least two operands, and output an operation result of lower bits by adding, to the bit information of the mantissa, a bit lost through a normalization operation and a rounding operation during the calculation of the at least two operands.

### MODE FOR INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

Several software techniques have been introduced to solve the limitations of the existing floating point arithmetic method. This is usually calculated by converting a number expressed with high precision to low precision or a fixed point.

As an example of a floating point arithmetic technique that uses a low-precision operator, there are a technique of expressing a number expressed with high precision as a sum of two low-precision expressions, and a technique of expressing high-precision operations by dividing the high-precision operations into low-precision operations.

However, in this technique, a high-precision addition is expressed as eight low-precision additions, and each operation has data dependencies, making it difficult to use instruction level parallelism available in up-to-date processors. However, when an error of the floating point addition operation may be immediately calculated, data dependence is reduced, making it easier to use the instruction level parallelism.

Meanwhile, a main goal of artificial intelligence semiconductors is to accelerate a matrix operation mainly used in a deep neural network (DNN). Since the matrix operation algorithm has high parallelism, the artificial intelligence semiconductors try to deploy as many hardware operators as possible. The method of deploying many operators is to lower the precision of the operators, and in the latest research, there is an effort to have a 4-bit operator by expressing a floating point with 4 bits. Deploying a low-precision operator is not a problem in terms of hardware, but has a problem in terms of software. It is well known that the performance of the deep neural network is greatly reduced when performing an operation with a floating point of too low precision. In particular, it is known that a convolution operation, etc., is not significantly affected by precision, whereas operations such as batch normalization react sensitively to precision. In conclusion, the precision of the artificial intelligence semiconductors cannot be lowered indefinitely.

High performance computing (HPC), such as the previous scientific calculations, requires high-precision operations, unlike artificial intelligence semiconductors, and for this purpose, a method of emulating high-precision operations in software using floating point operators supported by processors is often selected.

The basis of this emulation technique is a technique similar to the floating point arithmetic technique using the low-precision operator described above, and one high-precision floating point may be expressed as the sum of two low-precision floating points. When emulating a double-precision floating point operation by expressing a double-precision floating point with two single-precision floating points, simply performing the same operations on the single-precision floating point is not sufficient, and additional operations may be required. For example, in the case of an addition operation, the floating point addition operations need to be executed 8 times. These addition operations are also data-dependent, and therefore, may not be processed in parallel with multiple operation units.

A commonly appearing addition pattern is a method of calculating an error of a floating point addition operation. For example, the addition error of variable x and variable y may be calculated as (x−(x+y))+y, which may seem like 0 at first glance, but due to the nature of floating point arithmetic, an error of x+y is output as a result value, not 0. This calculation expression should perform a calculation in the order of parentheses, and since the calculation expression uses the previous output as the next input, it can be seen that the data dependence is very high.

For this reason, the existing floating point arithmetic technique has been implemented and used in software only in applications that require ultra-high precision, and has not been used in applications such as artificial intelligence that require ultra-high speed.

Meanwhile, the main focus of the deep learning processor design is to put many operators into a fixed area, and for this purpose, the use of high-precision floating point operators is becoming reluctant. However, it is also true that the high-precision floating point arithmetic is sometimes necessary for the algorithmic performance of the deep learning.

The embodiment of the present disclosure can accelerate the high-precision arithmetic by adding, to the floating point operator, the hardware that calculates the error in the floating point addition operation, and can configure an efficient processor through instructions supporting the same.

Hereinafter, exemplary embodiments of the present disclosure will be described with reference to the accompanying drawings.

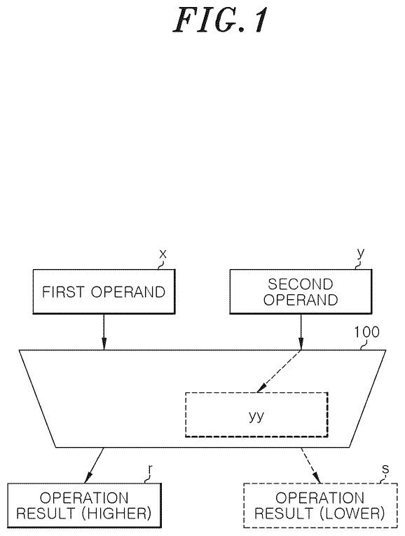

FIG. 1 is a conceptual diagram of an apparatus 100 for floating point arithmetic according to an embodiment of the present disclosure.

As illustrated in FIG. 1, the apparatus 100 for floating point arithmetic according to an embodiment of the present disclosure may input at least two operands, for example, a first operand (x) and a second operand (y), and calculate the input first operand (x) and second operand (y) to output a higher N-bit operation result r and a lower N-bit operation result (s), respectively.

The existing floating point arithmetic technique implemented, for example, two 8-bit inputs as two 8-bit outputs, but according to the apparatus 100 for floating point arithmetic according to an embodiment of the present disclosure, two 8-bit inputs are implemented as one 16-bit output and one 8-bit output.

In this case, in an embodiment of the present disclosure, a mantissa is truncated during the process of adjusting exponent of two operands (x, y) to be the same during a floating point addition or subtraction operation. In this case, it is possible to increase accuracy of operation by preserving bits (yy) that are shifted and discarded without discarding the bits (yy).

Accordingly, in an embodiment of the present disclosure, 2N-bit addition and subtraction operations are indirectly implemented to support an operation process requiring higher accuracy in hardware with an N-bit floating point arithmetic system.

In addition, an embodiment of the present disclosure is to provide a floating point arithmetic technology capable of reducing unnecessary operations and simplifying existing operations by attaching additional hardware to a general floating point adder or subtractor.

In addition, an embodiment of the present disclosure is to provide a floating point arithmetic technology of extending an N-bit floating point arithmetic process, for example, an N-bit floating point addition process (x+y=z), to a 2N-bit double-precision floating point arithmetic process and implementing two N-bit single-precision pairs (r, s) each. The 2N-bit double precision floating point arithmetic may be expressed as [Equation 1] below.

$$( x , 0 ) + ( y , yy ) = ( r , s ) ⇒ ( z , zz ) \qquad [ Equation 1 ]$$

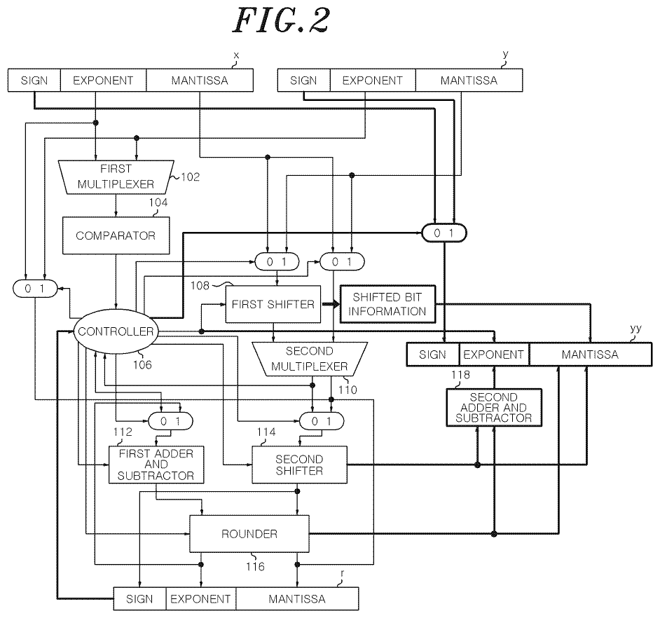

FIG. 2 is a detailed block diagram of the apparatus 100 for floating point arithmetic according to an embodiment of the present disclosure.

As illustrated in FIG. 2, the apparatus 100 for floating point arithmetic according to an embodiment of the present disclosure includes a first multiplexer 102, a comparator 104, a controller 106, a first shifter 108, and a first multiplexer 110, a first adder and subtractor 112, a second shifter 114, a rounder 116, and a second adder and subtractor 118.

In FIG. 2, x, y, r, and yy conceptually represent a flip-flop data set for expressing a floating point, x and y represent a flip-flop data set in which the input operand is stored, and r represents a flip-flop data set in which a first operation result is stored. In particular, in an embodiment of the present disclosure, an operand with an exponent of a smaller value among operands (x, y), for example, a flip-flop data set of discarded bit information of y may be expressed as yy.

Each data set includes a sign, an exponent, and a mantissa, and the precision of the apparatus for floating point arithmetic is limited by the number of bits used to represent the mantissa. The precision of the apparatus 100 for which floating point arithmetic is determined depends on the specific application. For example, a single 32-bit format with a 1-bit sign, an 8-bit exponent, and a 23-bit mantissa may be defined.

The apparatus 100 for floating point arithmetic according to an embodiment of the present disclosure requires, for example, two N-bit floating point pairs. When it is assumed that an arbitrary floating point pair is (r, s), the (r, s) may not be directly constructed on hardware that supports the N-bit single-precision floating point. Therefore, instead of (r, s), (r, 0) may be used in the first operation.

When it is assumed that x>y for the first operand (x) and the second operand (y), the apparatus 100 for floating point arithmetic according to an embodiment of the present disclosure may construct (y, yy) for the operation as shown in [Equation 2] below to derive an s value.

$$( x , 0 ) \pm ( y , 0 ) = ( r , s ) \qquad [ Equation 2 ]$$

Specifically, the first adder and subtractor 112 of the apparatus 100 for floating point arithmetic performs the operation process of r=x+y, and in this process, the controller 106 of the apparatus 100 for floating point arithmetic may recover the lost information through [Equation 3] below.

$$s = ( ( ( ( x - r ) + y ) + yy ) + xx ) \qquad [ Equation 3 ]$$

In this case, since xx=0, the last addition may be omitted, and the apparatus 100 for floating point arithmetic according to an embodiment of the present disclosure may preserve a yy value by using bits discarded during the mantissa truncation process of y.

In addition, the rounder 116 of the apparatus 100 for floating point arithmetic may undergo normalization and rounding processes when calculating r=x+y, and the controller 106 of the apparatus 100 for floating point arithmetic may preserve bits lost during this process.

In other words, the apparatus 100 for floating point arithmetic may immediately configure s by adding the bits lost during the normalization operation and rounding operation to the bit information of the mantissa of y. In other words, the apparatus 100 for floating point arithmetic may configure yy by adding the bits lost during the normalization operation and rounding operation to the bits discarded during the mantissa truncation process of y, and then may configure s through the additional addition/subtraction three times (when xx=0) or four times according to [Equation 3].

The newly configured yy is stored as a separate flip-flop data set, and this result can be written-back to the existing register file along with the calculated y value or left in a separate register.

A method of configuring yy during the truncation process will be described below.

The input exponents of the first operand (x) and the second operand (y) pass through the first multiplexer 102 and the comparator 104 and are output as a magnitude relationship comparison operation result, and the first shifter 108 may perform the shift operation so that the exponents of the first operand (x) and the second operand (y) have the same value.

Here, the first shifter 108 may perform a right shift operation under the control of the controller 106, and based on the comparison operation result of the comparator 104, the controller 106 may store an operand having an exponent of a smaller value among the first operand (x) and the second operand (y), for example, the bit information of the mantissa of the second operand (y) in the flip-flop data set (yy).

During the right shift operation of the first shifter 108, part of the mantissa of the second operand (y) may be truncated, and the truncated and discarded bit information may be stored in the separate flip-flop data set (yy) by the controller 106.

That is, when truncating the mantissa, the control signal input from the controller 106 to the first shifter 108 has information on how many bits the mantissa of the second operand (y) is to be shifted. This value is a value corresponding to a difference eD between an exponent ex of the first operand (x) and an exponent ey of the second operand (y), and the truncated eD bit may be shifted as is and may be input to the mantissa of the flip-flop data set (yy) storing the discarded bit information in order from the most significant bit (MSB).

The value of [Equation 4] below may be input to the exponent of the flip-flop data set (yy) that stores the discarded bit information.

$${e}_{x} - m - 1 \qquad [ Equation 4 ]$$

Here, m is a bit length of the mantissa, and a sign of the flip-flop data set (yy) storing the discarded bit information is the same as the sign of the second operand (y). The bit information of the exponent of the flip-flop data set (yy) is a provisional value and waits until the result of r=x+y is calculated without the need to undergo the separate normalization operation.

When the flip-flop data set (r) in which the first operation result is stored is primarily calculated by the operation process of the first adder and subtractor 112 based on the control of the controller 106, the mantissa of r may undergo the left or right shift operation by the second shifter 114 for normalization. When the left shift operation is performed, the mantissa of the flip-flop data set (yy) in which the discarded bits are stored may be used, but in order not to break the generality of the system, 0 may be filled in the conventional way. Instead, the mantissa of the flip-flop data set (yy) where the discarded bits are stored should also perform the left shift operation, and the exponent needs to be adjusted accordingly.

To this end, the apparatus 100 for floating point arithmetic according to an embodiment of the present disclosure may further include the second adder and subtractor 118 connected to the exponent of the flip-flop data set (yy) in which the discarded bits are stored.

When the mantissa needs to undergo the right shift operation as a result of normalization of the flip-flop data set (r) in which the first operation result is stored, an additional bit is lost in the mantissa of the flip-flop data set (r) in which the first operation result is stored. This bit may be directly attached to the most significant bit (MSB) of the flip-flop data set (yy) in which the previously preserved discarded bit is stored. Likewise, the exponent of the flip-flop data set (yy) in which the discarded bits are stored needs to be adjusted accordingly.

The flip-flop data set (yy) generated through this process may undergo the normalization operation and rounding operation, and finally, s of the lower N bits s may be output. In this case, the normalization operation can be used by adding the same module as the existing hardware module, or can be used by reusing one module.

In order to input the sign of the flip-flop data set (yy), in actual implementation, it is necessary to determine which floating point is larger among the two inputs, the first operand (x) and the second operand (y), so the exponents of the two inputs should undergo the first multiplexer 102 and the comparator 104. According to the operation result of the comparator 104, the sign of the input having a small exponent may be input as the sign of the flip-flop data set (yy).

Therefore, the sign of the flip-flop data set (yy) may be connected to the signs of the first operand (x) and the second operand (y) through a 2:1 MUX. However, when the signs of the first operand (x) and the second operand (y) are different from each other and the exponents ex and ey are the same, once the sign of the flip-flop data set (yy) is filled with 0, and the r value obtained by adding the first operand (x) and the second operand (y) is calculated, the same effect may be obtained by substituting the bit opposite to the sign of r into the sign of the flip-flop data set (yy).

Meanwhile, in the case of the subtraction operation as shown in [Equation 5] below, the basic configuration is the same as the addition operation, but the only difference is that the signs of the input second operand (y) and the discarded bit (yy) of the second operand are negative.

$$( x , xx ) - ( y , yy ) = ( r , s ) ⇒ ( z , zz ) \qquad [ Equation 5 ]$$

In the floating point arithmetic, the exponent comparison operation is independent of the sign of the input value, and the mantissa operation also supports the subtraction operation in the existing hardware, and therefore, can be equally applied to the embodiment of the present disclosure.

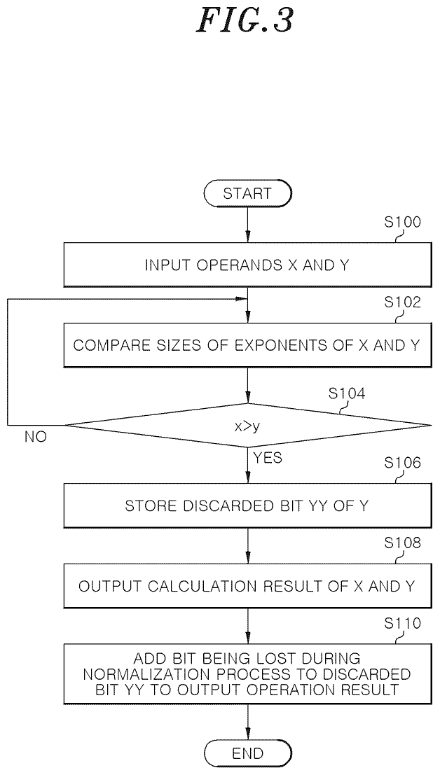

FIG. 3 is a flowchart illustrating the method of floating point arithmetic of the apparatus 100 for floating point arithmetic according to the embodiment of the present disclosure.

As illustrated in FIG. 3, when the first operand (x) and the second operand (y) are input to the apparatus 100 for floating point arithmetic, the exponents of the first operand (x) and the second operand (y) may undergo the operation process of the first multiplexer 102 and the comparator 104 (S100).

Thereafter, the apparatus 100 for floating point arithmetic may compare the sizes of the exponents of the first operand (x) and the second operand (y) through the operation process of the comparator 104 (S102).

As an operation result of the comparator 104, when the exponent of the second operand (y) is determined to be a smaller value than the exponent of the first operand (x) (S104), the controller 106 may store the discarded bit information of the mantissa of the second operand (y) in the flip-flop data set (yy) during the shift operation (S106). That is, in the floating point arithmetic process, the shift operation, for example, the right shift operation, is performed so that the exponents of the first operand (x) and the second operand (y) have the same value. In the embodiment of the present disclosure, during this right shift operation, the discarded bit information of the mantissa of the second operand (y), which has a small value of the exponent, is temporarily stored in the flip-flop.

Thereafter, the first adder and subtractor 112 of the apparatus 100 for floating point arithmetic may output the first operation result of the first operand (x) and the second operand (y) (S108). The first operation result may be exemplified by the flip-flop data set (r) in FIG. 2.

In this case, the controller 106 of the apparatus 100 for floating point arithmetic may control the second adder and subtractor 118 to add the bits lost during the normalization operation of the second shifter 114 to the discarded bits of the flip-flop data set (yy), thereby outputting the final operation result(s) (S110).

The embodiment of FIG. 3 illustrates a case where the exponent of the second operand (y) is smaller than the exponent of the first operand (x), and the same may also be in the opposite case (when the exponent of the second operand (y) is larger than the exponent of the first operand (x)).

Referring to FIG. 2, the apparatus 100 for floating point arithmetic outputs the operation result of comparing the magnitude relationship between the first operand (x) and the second operand (y) through the first multiplexer 102 and the comparator 104, and the controller 106 may determine the operation order of the first operand (x) and the second operand (y) based on the operation result. For example, as can be seen from the two MUXes (1:2), the exponent of the operand with the smaller exponent value among the operands may be input through the leftmost MUX.

Therefore, in both the x>y situation and the x<y situation, since the operation process of comparing the magnitude relationship of the exponents of the input operands is undergone, the same operation process may be applied after the right shift operation.

According to the embodiment of the present disclosure as described above, it is expected to be easy to apply in the HPC market and deep learning processor market due to the high-precision arithmetic, and to be easy to apply to the existing products due to the minimal hardware changes.

In addition, according to the embodiment of the present disclosure, the operation process may be reduced to one comparison operation and four or six addition/subtraction operations to derive single-precision floating point (z, zz) pairs. In the case of the first operation, since (x, xx) pairs may not be confirmed, (x, 0) pairs are used, so only four operations are required. In the following operation, since the previously derived results are used again as (x, xx) and (y, yy), two additional operations are required, so a total of six operations are required.

An example of an operation that requires high accuracy may include batch normalization and backward pass among deep learning operations. In this case, the gradual loss of value accuracy may be minimized by accumulating the floating points with different exponent values several times.

When accumulating N values, in the embodiment of the present disclosure, since the (x, 0) pair is used for the first operation, only four operations are required. To take advantage of this, a tree-type addition method (adder tree) may be introduced. With this method, the floating point arithmetic technique may be implemented with (5N-6) operations. When N is large enough, it is expected to improve speed by 37.5% compared to the previous one.

“Meanwhile, the combinations of each block in the attached block diagrams and each step in the flowcharts may be executed by computer program instructions. These computer program instructions may be loaded onto a general-purpose computer, a special-purpose computer, or other programmable data processing apparatus, such that the instructions, when executed by the computer or other programmable data processing apparatus, create means for performing the functions specified in each block of the block diagrams.

These computer program instructions may also be stored in a computer-usable or computer-readable storage medium that can direct a computer or other programmable data processing apparatus to function in a particular manner, such that the instructions stored in the computer-usable or computer-readable storage medium produce an article of manufacture including instruction means for performing the functions specified in each block of the block diagrams.

Moreover, the computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in each block of the block diagrams.

Additionally, each block may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved.”

### INDUSTRIAL APPLICABILITY

According to the embodiment of the present disclosure, it is expected to be easy to apply in the HPC market and deep learning processor market due to the high-precision arithmetic, and to be easy to apply to the existing products due to the minimal hardware changes.

1. A method for floating point arithmetic performed by an apparatus for floating point arithmetic, the method comprising:
storing bit information of a mantissa of at least one operand selected from among at least two operands based on a result of comparing exponents of the at least two operands being input;
outputting an operation result of higher bits by calculating the at least two operands; and
outputting an operation result of lower bits by adding, to the bit information of the mantissa of the at least one operand, a bit lost through a normalization operation and a rounding operation in the calculation of the at least two operands.

2. The method of claim 1, wherein the storing the bit information of the mantissa of the at least one operand includes:
performing a shift operation of the at least two operands so that the exponents of the at least two operands have a same value; and
storing the bit information of the mantissa of an operand having the exponent of a smaller value among the at least two operands in the shift operation.

3. The method of claim 2, wherein the shift operation is a right shift operation.

4. A method for floating point arithmetic performed by apparatus for floating point arithmetic, the method comprising:
performing a right shift operation of a first operand and a second operand so that an exponent of the first operand and an exponent of the second operand being input have a same value;
storing discarded bits of the second operand during the right shift operation of the first operand and the second operand;
calculating the first operand and the second operand and outputting an operation result of higher N bits; and
outputting an operation result of lower N bits by adding, to the discarded bits of the second operand, bits lost through a normalization operation and a rounding operation in the calculation of the right shift operation of the first operand and the second operand.

5. The method of claim 4, wherein the discarded bit is stored in a mantissa of a flip-flop of the apparatus for floating point arithmetic.

6. The method of claim 4, wherein the adding includes performing a left shift operation or a right shift operation on the mantissa of the operation result of the higher N bits.

7. The method of claim 6, wherein the mantissa of the discarded bit in the left shift operation is left shifted.

8. The method of claim 4, wherein the lost bit in the right shift operation is added to a most significant bit of the discarded bit.

9. The method of claim 6, further comprising adjusting the exponent of the discarded bit in response to the left shift operation or the right shift operation.

10. The method of claim 4, further comprising comparing the sizes of the exponents of the first operand and the second operand and inputting a sign of the discarded bit.

11. An apparatus for floating point arithmetic, the apparatus comprising:
a comparator configured to compare exponents of at least two operands;
a controller configured to control to store bit information of a mantissa of at least one operand among the at least two operands in a flip-flop based on a comparison result of the comparator;
a first adder and subtractor configured to perform an addition operation or a subtraction operation on the at least two operands based on the control of the controller and output an operation result of a higher bit; and
a second adder and subtractor configured to output an operation result by a normalization operation and a rounding operation after the addition or subtraction operation of the first adder and subtractor,
wherein the controller is configured to control the second adder and subtractor to output an operation result of lower bits by adding bits lost through a normalization operation and a rounding operation to the bit information of the mantissa of the at least one operand.

12. The apparatus of claim 11, further comprising a shifter configured to perform a shift operation of the at least two operands so that the exponents of the at least two operands have a same value,
wherein the controller is configured to store, in the flip-flop, bit information of a mantissa of an operand having an exponent of a smaller value among the at least two operands during the shift operation.

13. The apparatus of claim 12, wherein the shift operation is a right shift operation.

14. The apparatus of claim 12, wherein the shifter is configured to perform a right shift operation of a first operand and a second operand so that exponents of a first operand and a second operand being input have the same value;
wherein the first adder and subtractor are configured to operate the first operand and the second operand and outputs an operation result of the higher N bits,
wherein the second adder and subtractor are configured to output an operation result of the lower N bits by the normalization operation and the rounding operation in the calculation of the first operand and the second operand, and
wherein the controller is configured to control a discarded bit of the second operand to be stored in the flip-flop during the right shift operation, and control the second adder subtractor to output the operation result of the lower N bits by adding the bit lost through the normalization operation and the rounding operation to the discarded bit.
